(19) United States
(12) Patent Application Publication
(10) Pub. No.: US 2024/0289672 A1
(43) Pub. Date: Aug. 29, 2024

(54) METHOD AND ARRANGEMENT FOR READING OUT THE STATES OF QUBITS IN A QUANTUM COMPUTING SYSTEM

(71) Applicant: IQM Finland Oy, Espoo (FI)

(72) Inventor: Pasi Lähteenmäki, Espoo (FI)

(21) Appl. No.: 18/559,670

(22) PCT Filed: Jun. 16, 2021
(86) PCT No.: PCT/FI2021/050457

§ 371 Date: Nov. 8, 2023

(51) Int. Cl. G06N 10/40; G06F 13/42

(52) U.S. Cl. CPC G06N 10/40; G06F 13/4282

(57) ABSTRACT

In a quantum computing system, each qubit can exhibit a coherent superposition of two quantum states. Reading out the state collapses the superposition into one of the states. Each of a plurality of threshold detectors has an input controllably couplable to a respective qubit. A superconductive parallel to serial converter has parallel inputs and a serial output, of which the parallel inputs are coupled to the outputs of the threshold detectors. A transmitter is coupled to the serial output of the superconductive parallel to serial converter and configured to transmit a signal obtained at said serial output across a boundary of the cryogenically cooled environment in which the qubits, the threshold detectors, the superconductive parallel to serial converter, and the transmitter are located.

### FIELD OF THE INVENTION

The invention is generally related to circuit hardware that is used in quantum computing and methods of using such circuit hardware. In particular, the invention is related to hardware and methods that are used to read out the states of qubits and to convey the obtained information out of the cryogenically cooled environment.

### BACKGROUND OF THE INVENTION

Quantum computing involves using qubits to perform calculations and repeatedly reading out the states that the qubits acquired as a result. In general, a qubit is a device capable of exhibiting a coherent superposition of two quantum states. This capability of qubits forms the basis of their superiority in computational performance compared to conventional digital registers, which can only store binary values, i.e. one or zero. Reading out the state of a qubit collapses the respective superposition into one of said two quantum states.

The actual physical implementation of a qubit and its readout mechanism may vary. One commonly used form of a qubit is a transmon, the state of which is described as a|0>+b|1>, where |0> is the ground state, |1> is the (first) excited state, and a and b are complex numbers for which |a|²+|b|²=1. From the readout perspective the essential quantity is |b|², which corresponds to the probability of the readout operation giving the result that the transmon qubit was in the excited state. Somewhat simplified, the state of a transmon qubit is represented by the momentary amount of stored energy in the qubit. A conventional way to read out the state of qubits of the transmon type involves coupling the qubit with a microwave resonator and detecting the resulting phase and amplitude shift with a microwave pulse interacting with the resonator.

In order to keep quantum noise from destroying the coherence of their states, qubits must be kept in a cryogenically cooled environment where the temperature is only some millikelvins above absolute zero. A significant part of the processing electronics is located in the surrounding room temperature environment, which necessitates building connections for conveying the signals across the interface between the two environments. Conventionally, the connections have had the form of rigid coaxial cables dimensioned for use at the high frequencies involved. However, as designers would like to increase the number of qubits in the quantum computing system, problems arise. With known technology such as frequency multiplexing, there is a practical limit to how many simultaneous readout operations can be accomplished with one pair of coaxial cables (readout input, signal output). One may be limited to e.g. reading out the states of only about 10 qubits simultaneously. In a large quantum computing system, a very large number of coaxial cables is thus needed.

The coaxial cables are relatively bulky, so they take a large amount of space in the cryostat that is employed to maintain the required extremely low temperature. They also conduct heat, which means that they must be effectively thermalized along the way in order not to place excessive burden to the relatively low cooling power that is available at the cold end of a dilution refrigerator that is the core instrument of the cryostat. These requirements make the coaxial-cable-based connections complicated and expensive and ultimately set a limit to the number of such connections that can be provided.

The solutions described in this text aim at solving the connectivity problems between the cryogenically cooled environment and the surrounding room temperature environment, essentially enabling reading out the states of a large number of qubits without the drawbacks of the previously known arrangements.

### SUMMARY

According to a first aspect there is provided an arrangement for reading out states of a plurality of qubits in a quantum computing system. Each of said qubits is capable of exhibiting a coherent superposition of two quantum states, and reading out the state of any of said qubits collapses the respective superposition into one of said two quantum states. The arrangement comprises a plurality of threshold detectors, each of said threshold detectors having an input and an output, of which said input is controllably couplable to a respective one of said plurality of qubits. The arrangement comprises a superconductive parallel to serial converter having a plurality of parallel inputs and a serial output, of which each of said parallel inputs is coupled to the output of a respective one of said threshold detectors. The arrangement further comprises a transmitter coupled to said serial output of the superconductive parallel to serial converter. Said transmitter is configured to transmit a signal obtained at said serial output across a boundary of a cryogenically cooled environment in which said qubits, said threshold detectors, said superconductive parallel to serial converter, and said transmitter are located.

According to an embodiment said qubits are transmon qubits, the states of which are represented by the momentary amount of energy stored in the respective transmon qubit. The threshold detectors may then be pulsed microwave photon counters configured to give one of two possible values at their output, indicative of whether the respective transmon qubit was in its ground state or first excited state. This involves the advantages associated with transmon qubits, such as decreased sensitivity to charge noise, as well as the advantage of enabling the use of fast and reliable readout circuitry.

According to an embodiment, said plurality of pulsed microwave photon counters are Josephson junction based single photon detectors. This involves the advantage of enabling the use of fast and reliable readout circuitry.

According to an embodiment, said plurality of pulsed microwave photon counters are bolometers. This involves the advantage of extremely fast response times in reading out the states of the qubits.

According to an embodiment, each of said plurality of pulsed microwave photon counters comprises a control input for receiving a control signal, and each of said plurality of pulsed microwave photon counters is responsive to control signal received through its control input by enabling the controllable coupling between it and the respective one of the plurality of qubits. This involves the advantage of maintaining good isolation between the readout circuitry and the qubit during other times than readout, improving the coherence time of the qubits.

According to an embodiment, there are as many of said threshold detectors as there are said qubits. This involves the advantage that the controllable couplings between qubits and their respective readout circuits can be tailored very accurately and the states of even all qubits can be read out simultaneously.

According to an embodiment, for at least one of said threshold detectors, there is a group of N of said qubits, where N is an integer. The arrangement may then comprise readout control means configured to controllably couple such at least one of said threshold detectors with a selected one of the corresponding group of qubits. This involves the advantage that fewer threshold detectors and fewer control lines are needed.

According to an embodiment, N is equal to or smaller than 5, preferably equal to 2. This involves the advantage that readout operations can be performed fast despite using common threshold detectors for multiple qubits.

According to an embodiment, said superconductive parallel to serial converter comprises single flux quantum (SFQ) based classical logic. This involves the advantage of very high operating rates in the parallel to serial conversion.

According to an embodiment, said superconductive parallel to serial converter comprises a chain of logic cells coupled in series, each logic cell in said chain of logic cells being configured to temporarily store a piece of digital information obtained from a respective one of said plurality of threshold detectors. This involves the advantage that relatively simple logical structures can be used for the parallel to serial conversion.

According to an embodiment, each logic cell in said chain of logic cells comprises a data input coupled to the output of a respective one of said pulsed microwave photon counters, a transfer input, and a transfer output. Each logic cell may then additionally comprise a register element coupled to said data input, said transfer input, and said transfer output, and a control input. Each logic cell in said chain of logic cells may then be configured to temporarily store in said register element a value obtained either from said data input or from said transfer input, depending on a control value received at said control input. This involves the advantage that relatively simple logical structures can be used for the parallel to serial conversion.

According to an embodiment, said transmitter comprises a microwave transducer configured to transmit said signal obtained at said serial output into a vacuum tube waveguide. This involves the advantage that compact structural solutions are available for the communications connection towards the room temperature environment.

According to an embodiment, said transmitter comprises an optical transmitter configured to transmit said signal obtained at said serial output into an optical fibre connection. This involves the advantage of rapid communication rates and immunity to electromagnetic interference in the communications connection towards the room temperature environment.

According to a second aspect, there is provided a quantum computing system, comprising a cryostat for establishing a cryogenically cooled environment, and an arrangement of the kind described above, located inside said cryostat within said cryogenically cooled environment.

According to a third aspect, there is provided a method for reading out states of a plurality of qubits in a quantum computing system. Said reading out involves collapsing a coherent superposition of two quantum states exhibited by the respective qubit into one of said two quantum states. The method comprises controllably establishing readout couplings between said plurality of qubits and a plurality of threshold detectors simultaneously, thus making each of said plurality of threshold detectors assume one two possible output values indicative of whether reading out the respective qubit made it collapse into a first one or a second one of said two quantum states. The method comprises subsequently transferring the values assumed by said plurality of threshold detectors out of said plurality of threshold detectors as a digital string, and transmitting said digital string out of the cryogenically cooled environment that contains said qubits and said threshold detectors.

According to an embodiment, said establishing of readout couplings is performed by controllably setting each of a plurality of pulsed microwave photon counters into resonance with a respective one of said plurality of qubits. This involves the advantage that transmon qubits can be utilised, with long coherence times and relative insensitivity to charge noise.

According to an embodiment, said transferring out of the values assumed by the plurality of threshold detectors involves storing said values into a shift register and reading them out of said shift register in serial form that constitutes said digital string. This involves the advantage that very fast, yet relatively simple logical circuitry can be used.

According to an embodiment, said transmitting of said digital string out of the cryogenically cooled environment is done using electromagnetic waves that propagate through a vacuum tube waveguide. This involves the advantage that compact structural solutions are available for the communications connection towards the room temperature environment.

According to an embodiment, said transmitting of said digital string out of the cryogenically cooled environment is done using optical pulses that propagate through an optical fibre connection. This involves the advantage of rapid communication rates and immunity to electromagnetic interference in the communications connection towards the room temperature environment.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 illustrates a known quantum computing system,

FIG. 2 illustrates an example of functional blocks within the cryogenically cooled environment,

FIG. 3 illustrates the combination of a qubit and a threshold detector,

FIG. 4 illustrates the combination of a group of qubits and a common threshold detector,

FIG. 5 illustrates one example of a qubit and a threshold detector,

FIG. 6 illustrates an example of a parallel to serial converter,

FIG. 7 illustrates an example of a superconductive parallel to serial converter implemented with SFQ-based classical logic, and

FIG. 8 illustrates an example of a SFQ circuit.

### DETAILED DESCRIPTION

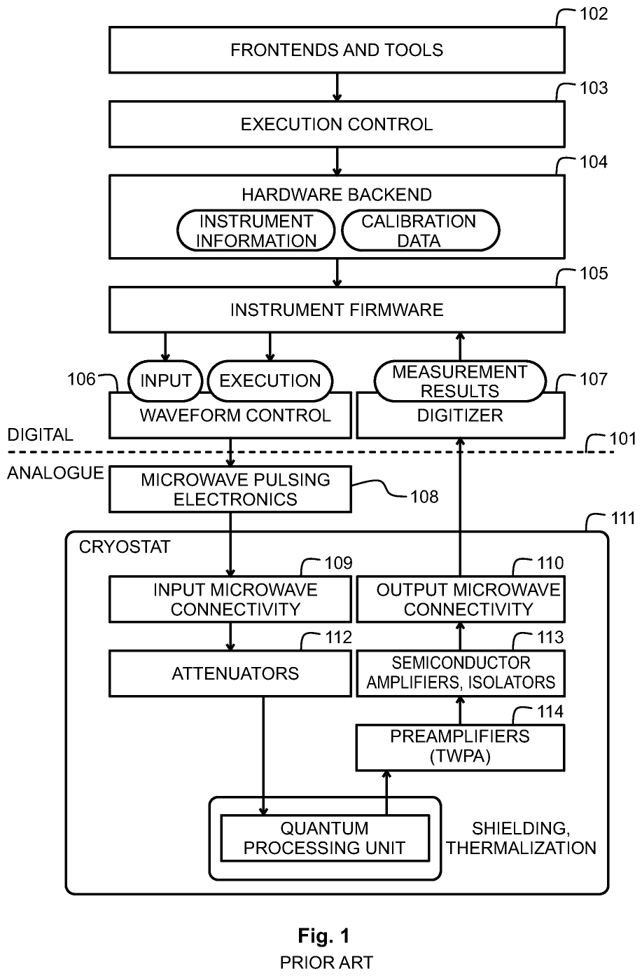

The known quantum computing system of FIG. 1 may be divided into a digital domain and an analogue domain, as illustrated by the dashed line 101. The whole of the digital domain is located in the room temperature environment. The designation “room temperature” does not require there to be actually some temperature commonly found in rooms where people live in.

It merely emphasizes that large portions of the overall system are such that do not need cryogenic cooling for operation.

Block 102 represents the so-called logical control layer, on which a variety of frontends and tools may be found. Block 103 may be called the experiment layer, which comprises various execution control functions. Block 104 is a backend layer, parts of which may be the instrument information and calibration data that are necessary for the correct operation of the system. Instrument firmware 105 is located on a drivers layer, where on the input side the inputs and execution instructions go to a waveform controller 106 and where a digitizer 107 provides measurement results as outputs.

Between the digital and analogue domains, digital to analogue conversions take place on the input side and correspondingly analogue to digital conversions take place on the output side. In this embodiment, communications between the cryogenically cooled environment and the room temperature environment take place on microwave frequencies. The microwave pulsing electronics 108 may still be located in the room temperature environment. Input and output microwave connectivity arrangements 109 and 110 convey the signals to and from the cryogenically cooled environment, shown as the cryostat 111 in FIG. 1. The input side comprises attenuators 112, while the output side comprises various amplifying stages, isolators, and associated circuitry, generally represented by blocks 113 and 114. The acronym TWPA comes from the expression travelling wave parametric amplifier.

At the core of the quantum computing system is the quantum processing unit 115. It is located at the coldest part of the cryostat 111 and requires careful shielding around it, as well as effective thermalization of all connections between it and the warmer parts.

The exact type and operation of the cryostat are not important to the present description. At the time of writing this description, a dilution refrigerator is the core cooling device in cryostats capable of achieving temperatures in the millikelvin range. The cooling operation of a dilution refrigerator is based on the peculiar tendency of liquid helium to spontaneously form one phase rich of the isotope 3He and another, 3He-poor phase in a vessel called the mixing chamber. By actively pumping 3He atoms across the phase boundary, one may create a cooling effect that cools down the mixing chamber—and anything thermally coupled to it—to temperatures of only some millikelvins.

The absolute value in watts of the cooling power of a dilution refrigerator is not very large. Therefor it is of primary importance to make the system generate as little heat as possible at its core parts and to keep the mixing chamber and its immediate surroundings thermally insulated as effectively as possible. As already mentioned earlier, the latter becomes the more difficult the more there are thermally conductive signal connections, like coaxial connections for example, between the quantum computing circuitry and the surrounding warmer parts of the arrangement.

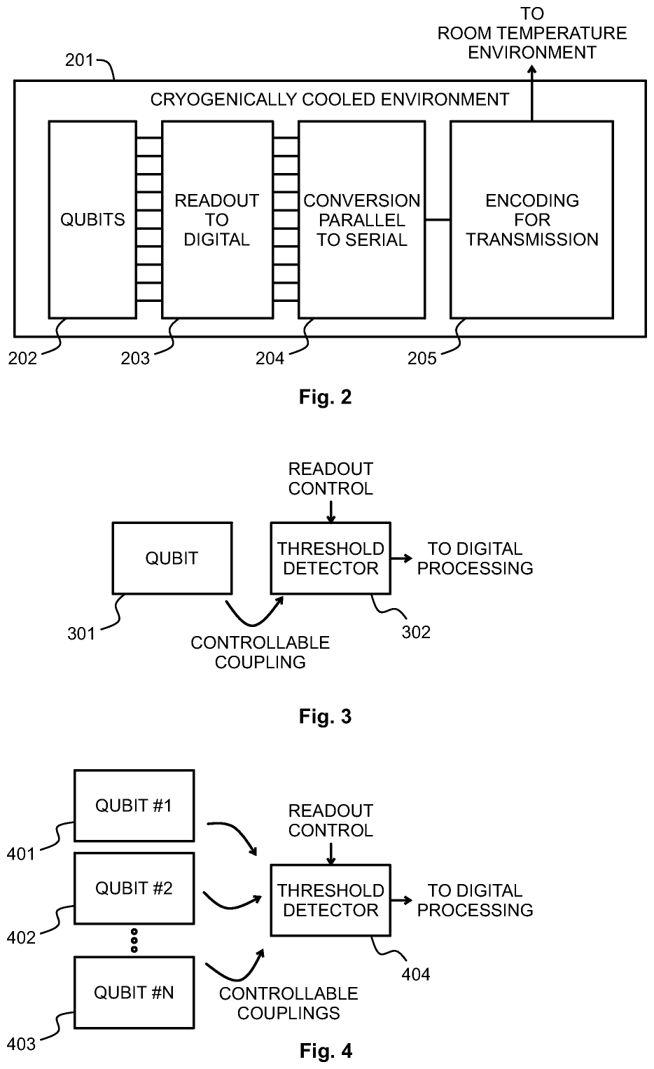

FIG. 2 illustrates some general-level features of a quantum computing system according to an embodiment. Block 201 represents the cryogenically cooled environment, as opposed to a surrounding room temperature environment.

In the arrangement of FIG. 2, block 202 represents a plurality of qubits. It may be assumed that an efficient quantum computing system may comprise at least some hundreds or thousands of qubits or even significantly more. Again, the exact number of qubits in the quantum computing system is of lesser importance to the present description, as long as there are so many of them that it becomes complicated to read out the states of a large number of them simultaneously using conventional methods.

The arrangement illustrated in FIG. 2 comprises a plurality of threshold detectors, represented by the readout to digital block 203. A threshold detector is a device that has an input and output, of which the output assumes one of two possible values depending on whether a signal present at the input is below or above a threshold. This conforms with the expression “readout to digital” in FIG. 2: the threshold detectors of block 203 are configured to produce binary signals indicative of the corresponding states of the qubits that were read out. The inputs of the threshold detectors in block 203 are controllably couplable to respective ones of the qubits in block 202 for performing the readout operations.

As illustrated by block 204, the arrangement comprises a parallel to serial converter. According to its nature, the parallel to serial converter comprises a plurality of parallel inputs and at least one serial output. Each of the parallel inputs is coupled or couplable to the output of a respective one of the threshold detectors of block 203. As the parallel to serial converter 204 is located in the cryogenically cooled environment 201, it is most advantageously a superconductive parallel to serial converter. This way it is possible to largely avoid the generation of stray heat that could otherwise take place due to ohmic losses in the parallel to serial converter.

At any moment when a plurality of the threshold detectors in block 203 perform a readout operation on the respective qubits simultaneously, the values assumed by such a plurality of threshold detectors constitutes a digital string. This digital string can be transferred out of the plurality of threshold detectors by reading it into the parallel to serial converter 204, using its parallel inputs. The parallel to serial converter 204 than outputs the digital string in serial form at its output.

Block 205 represents a transmitter that is coupled to the serial output of the superconductive parallel to serial converter 204. The transmitter in block 205 is configured to transmit the signal (i.e. the digital string) obtained at said serial output across the boundary of the cryogenically cooled environment 201, to further processing in the surrounding room temperature environment. Because the information to be transmitted comes readily in digital form, many kinds of transmitters that are known as such for the purpose of transmitting digital data fast over a local, relatively short connection can be employed. Some advantageous examples of such transmitters are described in more detail later in this text.

The immediate conversion into digital form of the qubit states that were read out makes it significantly simpler to bring out of the cryostat signals that represent the current outcome of a quantum computing operation. This is an important difference to conventional systems like that of FIG. 1, in which the raw outputs of the readout operations had to be conveyed out of the cryostat for further processing. As will be explained in more detail below, this difference enables significant simplification of the connection hardware between the cryogenically cooled environment and the surrounding room temperature environment.

FIG. 3 illustrates an embodiment in which there are as many threshold detectors in block 203 as there are qubits in block 202. In other words, in such an embodiment there are one-to-one relationships between qubits 301 and their respective threshold detectors 302. In order to keep the threshold detector 302 from interfering with the coherent quantum states of the qubit 301, it is advantageous to have a controllable coupling therebetween. The value of a readout control signal then determines, whether the controllable coupling is on (during readout) or off (otherwise).

FIG. 4 illustrates another embodiment, in which for at least one threshold detector 404 there is a group of N qubits 401 to 403. The arrangement then comprises readout control means that are configured to controllably couple the threshold detector 404 with a selected one of the corresponding group of qubits. If this approach is used throughout the whole system, allocating a group of N qubits for each individual threshold detector, only one N:th of the whole plurality of qubits in the quantum computing system may be read simultaneously. On the other hand, the required number of threshold detectors and readout control lines becomes correspondingly smaller.

A mixture of embodiments according to FIGS. 3 and 4 is possible, so that for certain qubits there is a dedicated threshold detector like in FIG. 3, while certain other qubits are allocated groupwise to corresponding shared threshold detectors.

In order to maintain the possibility of reading out the states of a large number of qubits simultaneously, it is advantageous to keep the value of N small in the embodiment of FIG. 4. The value of N may be for example equal to or smaller than 5, or even equal to just 2. It is not necessary to have the same value of N for each group of qubits.

The general principle explained above applies irrespective of which technology is selected for the actual implementation of the qubits. In order to provide some more detailed examples, in the following the qubits are transmon qubits, the states of which are represented (from the readout perspective) by the momentary amount of energy stored in the respective transmon qubit. In such a case the threshold detectors may be pulsed microwave photon counters. According to the principle of threshold detection, the pulsed microwave photon counters are configured to give one of two possible values at their output, indicative of whether the respective transmon qubit was in its ground state or first excited state.

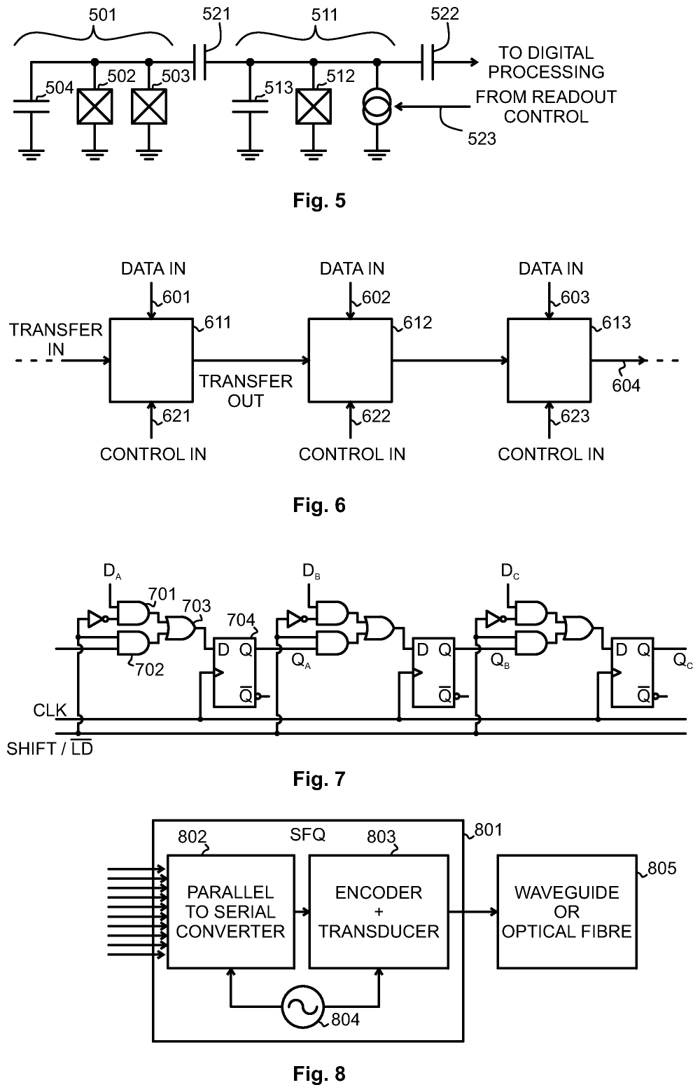

One advantageous form of a transmon qubit is a nonlinear resonant circuit that comprises a Joseph-junction (or an array of Josephson junctions) son shunted with a capacitance. In FIG. 5, the left-hand portion 501 constitutes such a transmon qubit, here with two Josephson junctions 502 and 503 in parallel and a capacitance 504 connected across them both. The middle portion 511 represents a pulsed microwave photon counter, which is here used as the threshold detector. It is basically another resonant quantum circuit, the resonance frequency of which can be controlled with a control signal that comes from a readout control arrangement. The pulsed microwave photon counter of FIG. 5 comprises a Josephson junction 512 shunted with a capacitance 513.

The principle and basic operation of a pulsed microwave photon counter such as that in FIG. 5 has been thoroughly described in the publication Y.-F. Chen et al: “Microwave Photon Counter Based on Josephson Junctions”, Phys. Rev. Lett. 107, 217401, published 14 Nov. 2011. When the pulsed microwave photon counter is in resonance with the respective transmon qubit, the tunnelling probability through the Josephson junction 512 may be several decades higher if the transmon qubit is in its first excited state (the |1> state) than if the transmon qubit was in its ground state (the |0> state). This results in the output of the pulsed microwave photon counter assuming a voltage that can be read out to the right in FIG. 5 as a digital “1”. If the transmon qubit was in its ground state, the output value of the pulsed microwave photon counter is read as a digital “0”.

Capacitive couplings 521 and 522 are provided between the transmon qubit and the pulsed microwave photon counter and between the last-mentioned and the further circuit (not shown in FIG. 5) that will process the outputs of the threshold detectors (pulsed microwave photon counters) further. In order not to unduly interfere with the coherent states of the qubit, it is important to keep the coupling between it and the corresponding threshold detector as small as possible at other times than reading out the state of the qubit. In the arrangement of FIG. 5 this is ensured by providing the capacitive coupling 521 and by keeping the pulsed microwave photon counter out of resonance with the qubit.

An arrangement of a transmon qubit and the corresponding pulsed microwave photon counter, like that in FIG. 5, can also employed in the case of FIG. 4 where a single threshold detector can be controllably coupled to any of a group of N qubits. Each qubit in the group may have an individual resonance frequency, and their common pulsed microwave photon counter can be tuned to meet any of the resonance frequencies of the qubits when needed.

An alternative form of a pulsed microwave photon counter that can be used as a threshold detector for a transmon qubit is a bolometer. As a general concept, a bolometer is not a threshold detector or a pulsed microwave photon counter in the sense meant here, but if a bolometer is sensitive enough, it can be made to act like a threshold detector. Making it a pulsed microwave photon counter then requires just some particular arrangement like near-threshold pulsing of bias in a superconducting bolometer with suitable parameters. Suitable forms of bolometers for this kind of use have been described for example in the publication R. Kokkoniemi et al: “Bolometer operating at the threshold for circuit quantum electrodynamics”, Nature, volume 586, pages 47-51 (2020), published 30 Sep. 2020. Just like the Josephson junction based single photon detector, a bolometer has the property of outputting one characteristic voltage when coupled to a transmon qubit in its first excited state and another characteristic voltage it the transmon qubit is in its ground state.

As shown in FIG. 5, it is advantageous to have each pulsed microwave photon counter comprise a control input 523 for receiving a control signal. This way it is possible to make each pulsed microwave photon counter responsive to a control signal received through its control input by enabling the controllable coupling between it and the respective qubit.

FIG. 6 illustrates an example of a superconductive parallel to serial converter. It has a plurality of parallel inputs 601 to 603 and a serial output 604. Each of the parallel inputs 601 to 603 is coupled to the output of a respective threshold detector (not shown in FIG. 6). The three elements 611 to 613 shown in FIG. 6 may be part of a long chain of similar, serially coupled elements that together form the superconductive parallel to serial converter. The horizontal line through the elements in FIG. 6 constitutes a transfer line, so that once a digital word has been read in through the parallel inputs from above, it can be transferred out of the serial output 604 by applying a sequence of transfer operations. Whether an individual element operates to store a new piece of digital information from the corresponding input (from above) or to transfer previously stored digital information horizontally) depends on a control command it receives through a corresponding control input 621 to 623.

An advantageous way to implement the superconductive parallel to serial converter is to use SFQ-based classical logic, where the acronym SFQ comes from Single Flux Quantum. In the embodiment of FIG. 7 the superconductive parallel to serial converter comprises a chain of logic cells coupled in series. Each cell is configured to temporarily store a piece (here: one bit) of digital information obtained from a respective threshold detector. The data inputs for receiving such pieces of digital information are marked as DA, DE, and Dc in FIG. 7.

Considering the leftmost logic cell as an example, it comprises two parallel AND gates 701 and 702, the outputs of which go to the inputs of an OR gate 703. The output of the OR gate 703 goes to the input of a register element; here to the input D of a latch 704. The output Q of the latch 704 constitutes a transfer output of the logic cell. The data input DA goes into one input of the upper AND gate 701, while a transfer input to the logic cell goes into one input of the lower AND gate 702. A control signal SHIFT/(/LD) goes as such to the other input of the lower AND gate 702 and inverted into the other input of the upper AND gate 701. Thus a logic value “0” of the control signal SHIFT/(/LD) makes the upper AND gate 701 forward the current value at the data input DA, and a logic value “1” makes the lower AND gate forward the current value of the transfer input. The OR gate 703 is just a buffer, the output of which becomes stored in the latch 704 as timed by the clock signal CLK.

SFQ logic can be utilized to implement building blocks such as the logic gates and latches in FIG. 7. SFQ is inherently compatible with microwave technology and allows using extremely high operating frequencies, up to hundreds of gigahertz. It also has very low power consumption, which is a big advantage taken that all consumed power will eventually turn into heat that must be removed from the cryostat. SFQ circuitry may be made self-clocking, which enables very practical asynchronous designs.

The high operating frequencies have two significant advantages concerning the use of SFQ logic for the superconductive parallel to serial converter. First, reading out the converted digital string in serial form can be done without excessive delay. Second, the SFQ logic circuit can directly drive e.g. a vacuum tube waveguide, which is one possible form of transferring the digital string out of the cryogenically cooled environment. As an example, if the SFQ logic operates ad 92.5 GHZ, one may utilize an EIA type WR10 waveguide which has a recommended band of 75-110 GHz and inner dimensions of 2.54 mm×1.27 mm, similar to a typical coaxial cable. Making the SFQ logic drive such a waveguide enables achieving a good signal to noise ratio without any complicated analog modulation schemes. At the receiving end, in the room temperature environment, one may use for example specific MMICs (monolithic microwave integrated circuits) to perform the necessary amplifying and sampling signals in this kind of frequency ranges.

In general, the part 801 of the arrangement that is implemented in SFQ logic may comprise the superconductive parallel to serial converter 802 and an encoder and transducer part 803, as well as a clock signal source 804 if needed, as shown in FIG. 8. As already mentioned possibility for the transducer is a microwave transducer that is configured to transmit the signal obtained at the serial output of the superconductive parallel to serial converter 802 into a vacuum tube waveguide. Another possibility is that the transmitter comprises an optical transmitter configured to transmit said signal into an optical fibre connection. The connection towards the room temperature environment is generally shown as 805 in FIG. 8.

The modulation scheme used for transmitting is preferably a digital DC-free modulation scheme such as on/off-type amplitude modulation. Using DC-free modulation for transmission is important if the connection to the room temperature environment is a waveguide, because waveguides cannot carry DC. The modulation generates essentially a digital band limited signal centered at for example the 92.5 GHz frequency mentioned above, the operability of which in SFQ has been demonstrated. Amplitude modulation can be accomplished with SFQ circuits known as such. If needed, encoding such as 8b/10b digital encoding can be utilized for facilitating clock recovery at the receiving end.

In addition to or in place of SFQ logic, it is possible to use any other low power classical Josephson-junction-based logic capable of operating efficiently at millikelvin temperatures. An example of such an alternative technology is an adiabatic quantum-flux-parametron (AQFP).

With the frequencies laid out above, it is possible to transmit readout results from thousands of qubits in less than 100 ns. The exact numbers depend on occupied bandwidth and its utilization efficiency. Only a single waveguide or optical fiber is needed, which makes it very much easier to thermalize the connection and also saves very much space inside the cryostat compared to known implementations where numerous coaxial cables would be needed for the same.

It is obvious to a person skilled in the art that with the advancement of technology, the basic idea of the invention may be implemented in various ways. For example, in place of SFQ logic or AQFP, it is possible to use circuitry based on quantum phase slip junctions, which are a kind of dual of Josephson junctions. The invention and its embodiments are thus not limited to the examples described above, instead they may vary within the scope of the claims.

1. An arrangement for reading out states of a plurality of qubits in a quantum computing system, wherein each of said qubits is capable of exhibiting a coherent superposition of two quantum states, and wherein reading out the state of any of said qubits collapses the respective superposition into one of said two quantum states, wherein the arrangement comprises:
a plurality of threshold detectors, each of said threshold detectors having an input and an output, of which said input is controllably couplable to a respective one of said plurality of qubits,
a superconductive parallel to serial converter having a plurality of parallel inputs and a serial output, of which each of said parallel inputs is coupled to the output of a respective one of said threshold detectors, and
a transmitter coupled to said serial output of the superconductive parallel to the serial converter, said transmitter being configured to transmit a signal obtained at said serial output across a boundary of a cryogenically cooled environment in which said qubits, said threshold detectors, said superconductive parallel to serial converter, and said transmitter are located.

2. The arrangement according to claim 1, wherein:
said qubits are transmon qubits, the states of which are represented by the momentary amounts of energy stored in the respective transmon qubit, and
said threshold detectors are a plurality of pulsed microwave photon counters configured to give one of two possible values at their output, indicative of whether the respective transmon qubit was in its ground state or first excited state.

3. The arrangement according to claim 2, wherein said plurality of pulsed microwave photon counters are Josephson junction based single photon detectors.

4. The arrangement according to claim 2, wherein said plurality of pulsed microwave photon counters are bolometers.

5. The arrangement according to claim 2, wherein:
each of said plurality of pulsed microwave photon counters comprises a control input for receiving a control signal, and
each of said plurality of pulsed microwave photon counters is responsive to a control signal received through its control input by enabling the controllable coupling between it and the respective one of the plurality of qubits.

6. The arrangement according to claim 1, wherein there are as many of said threshold detectors as there are said qubits.

7. The arrangement according to claim 1, wherein:
for at least one of said threshold detectors, there is a group of N of said qubits, where N is an integer, and
the arrangement comprises readout control means configured to controllably couple such that at least one of said threshold detectors with a selected one of the group of N of said qubits.

8. The arrangement according to claim 7, wherein N is equal to or smaller than 5.

9. The arrangement according to claim 1, wherein said superconductive parallel to serial converter comprises single flux quantum (later SFQ) based classical logic.

10. The arrangement according to claim 9, wherein said superconductive parallel to serial converter comprises a chain of logic cells coupled in series, each logic cell in said chain of logic cells being configured to temporarily store a piece of digital information obtained from a respective one of said plurality of threshold detectors.

11. The arrangement according to claim 10, wherein said threshold detectors are a plurality of pulsed microwave photon counters, and wherein each logic cell in said chain of logic cells comprises:
a data input coupled to the output of a respective one of said plurality of pulsed microwave photon counters,
a transfer input and a transfer output,
a register element coupled to said data input, said transfer input, and said transfer output, and
a control input,
and wherein each logic cell in said chain of logic cells is configured to temporarily store in said register element a value obtained either from said data input or from said transfer input, depending on a control value received at said control input.

12. The arrangement according to claim 1, wherein said transmitter comprises a microwave transducer configured to transmit said signal obtained at said serial output into a vacuum tube waveguide.

13. The arrangement according to claim 1, wherein said transmitter comprises an optical transmitter configured to transmit said signal obtained at said serial output into an optical fibre connection.

14. A quantum computing system, comprising:
a cryostat for establishing a cryogenically cooled environment, and
an arrangement according to claim 1, located inside said cryostat within said cryogenically cooled environment.

15. A method for reading out states of a plurality of qubits in a quantum computing system, wherein said reading out involves collapsing a coherent superposition of two quantum states exhibited by the respective qubit into one of said two quantum states, the method comprising:
controllably establishing readout couplings between said plurality of qubits and a plurality of threshold detectors simultaneously, thus making each of said plurality of threshold detectors assume one of two possible output values indicative of whether reading out the respective qubit made it collapse into a first one or a second one of said two quantum states, and
subsequently transferring the values assumed by said plurality of threshold detectors out of said plurality of threshold detectors as a digital string, and transmitting said digital string out of the cryogenically cooled environment that contains said qubits and said threshold detectors.

16. The method according to claim 15, wherein said establishing of readout couplings is performed by controllably setting each of a plurality of pulsed microwave photon counters into resonance with a respective one of said plurality of qubits.

17. The method according to claim 15, wherein said transferring out of the values assumed by the plurality of threshold detectors involves storing said values into a shift register and reading them out of said shift register in serial form that constitutes said digital string.

18. The method according to claim 15, wherein said transmitting of said digital string out of the cryogenically cooled environment is done using electromagnetic waves that propagate through a vacuum tube waveguide.

19. A The method according to claim 15, wherein said transmitting of said digital string out of the cryogenically cooled environment is done using optical pulses that propagate through an optical fibre connection.
